(19) United States
(12) Patent Application Publication
(10) Pub. No.: US 2012/0298122 A1
(43) Pub. Date: Nov. 29, 2012

(54) REGISTERED BANDED CIGARETTE PAPER, CIGARETTES, AND METHOD OF MANUFACTURE

(75) Inventors: Timothy S. Sherwood, Midlothian, VA (US); John F. Cunningham, Richmond, VA (US)

(73) Assignee: Philip Morris USA Inc., Richmond, VA (US)

(21) Appl. No.: 13/447,914

(22) Filed: Apr. 16, 2012

Related U.S. Application Data
(63) Continuation of application No. 13/222,355, filed on Aug. 31, 2011, now abandoned.
Application No. 13/222,355 is a continuation of application No. 12/674,878, now abandoned.
(60) Provisional application No. 60/935,639, filed on Aug. 23, 2007.

(51) Int. Cl. B32B 3/10; A24C 5/00; B32B 37/18; A24D 1/16

(52) U.S. Cl. 131/280; 131/365; 156/292; 428/189

(57) ABSTRACT

Registered banded wrapper, cigarettes using that wrapper paper, and methods of making cigarettes with that banded paper result in banded regions of cigarette paper which begin at substantially the same location on each cigarette. With the banded region positioned at a preferred predetermined distance from the end of the cigarette, cigarettes made with such paper exhibit an improved ignition propensity compared with random or quasi-randomly positioned banded regions.

### SUMMARY

This disclosure broadly concerns cigarettes and cigarette wrapping paper having one or more circumferential bands. In addition, this disclosure deals with a method of making banded cigarette wrapping paper so that bands of individual cigarettes are substantially uniformly positioned relative to structural features of the cigarette. In other aspects, the disclosure relates to cigarettes in which bands are uniformly positioned relative to features of a finished cigarette.

Heretofore, banded wrapper paper for cigarettes exhibited bands of preferred widths spaced longitudinally along the length of the paper by a preferred nominal distance. Using that paper, finished cigarettes had bands randomly, or quasi-randomly, positioned relative to structural features of the cigarette, such as the lightable end, or the filter end, or the mouth end, or the filter itself.

Where cigarettes incorporate banded wrapper paper to regulate self-extinguishment, burn promotion, and the like, that random or quasi-random band positioning may give inconsistent results to such characteristics as self-extinction, burn promotion, and the like. Currently, regulatory agencies have begun imposing requirements for characteristics such as self-extinction on cigarettes offered for sale in particular jurisdictions. That randomness or quasi-randomness in structural features of cigarettes can complicate compliance with such regulations.

In accordance with a method of this disclosure, a nominal finished length for a cigarette tobacco rod may be selected. A predetermined position for at least one band relative to a structural feature of the finished cigarette may be selected or determined. The number of bands for each finished cigarette may be chosen or selected. A predetermined width for the band(s) may be selected from a preferred range of band widths, width being measured along the longitudinal length of the tobacco rod. The predetermined band width, and predetermined position are then correlated with the nominal finished length of the tobacco rod by adjusting spacing between bands on the cigarette paper such that band positioning occurs at substantially the same location on each finished cigarette.

The cigarette paper according to this disclosure has transverse bands spaced from one another such that the relationship between one or more band widths and the inter-band spacing corresponds to the nominal length of a tobacco rod. Preferably, the cigarette paper has bands positioned in accordance with the features described above.

A finished cigarette according to this disclosure has a tobacco rod of nominal length, may include a filter, and preferably is manufactured with a cigarette paper as described above. The cigarette, specifically the tobacco rod, has a lightable end. The tobacco rod also has a mouth end or filter end. Where a filter is used, it is attached to the filter end of the tobacco rod in a conventional manner. The wrapper paper for the cigarette preferably includes at least one band located at a first predetermined distance from either the lightable end or the filter end, where the predetermined distance is essentially constant from one cigarette to the next. If desired, another band may be positioned a second predetermined distance from the other of the lightable end and the filter end. Further, more than two bands can be provided on each cigarette, if desired.

Preferably, the first predetermined distance is selected in the range of about 12 mm to about 18 mm from the lightable end, most preferably about 15 mm. In addition, the preferred range for band width lies between about 5 mm and about 7 mm.

Starting from a first location on banded cigarette paper for making cigarettes with band locations registered relative the finished cigarette structure, and ending at a second location on that cigarette paper, the following pattern exists:

K₁,K₂,K₃,K₂, K₁;

where K₁ corresponds to spacing between the first predetermined distance on the finished cigarette structure and a first band; K₂ corresponds to spacing between the first band and a last band of the finished cigarette; and K₃ corresponds to twice the second predetermined spacing, i.e., between the last band and a second location (e.g., the filter end or mouth end) on the finished cigarette structure. For that pattern, the sum of 2K₁+2K₂+K₃+4w is essentially equal to 2l, where w is the width of a band, and l is the nominal length of the tobacco rod for the finished cigarette.

### BRIEF DESCRIPTION OF THE DRAWINGS

FIG. 1 is a perspective view of a cigarette according to this disclosure;

FIG. 2 depicts a plan view of a first embodiment of the wrapper paper according to this disclosure;

FIG. 3 depicts a plan view of a second embodiment of the wrapper paper according to this disclosure;

FIG. 4 depicts a plan view of a third embodiment of the wrapper paper according to this disclosure;

FIG. 5 shows a graph of the percent full-length burns for cigarettes having a banded region beginning 12-18 mm from the lit end of the cigarette versus the percent full-length burns for cigarettes having a randomly positioned banded region; and

FIG. 6 is a schematic diagram showing portions of the cigarette manufacturing process.

### DESCRIPTION OF PREFERRED EMBODIMENTS

As used here, “registration” or “registered” means to make or adjust so as to correspond substantially exactly, and the “lightable end” or “lit end” of a cigarette or cigarette tobacco rod refers to the end of the cigarette or cigarette tobacco rod intended to be lit when smoking starts. Registration of the location of the beginning of a banded region from the lit end of a cigarette may further be used to minimize the number of cigarette self-extinguishments. Where the term “about” is used in relation to a number, it is intended that such number has a tolerance of plus or minus 5%,

### Tobacco

For cigarettes made according to this disclosure, suitable types of tobacco materials that may be used include, but are not limited to, flue-cured tobacco, Burley tobacco, Maryland tobacco, Oriental tobacco, rare tobacco, specialty tobacco, blends thereof, and the like. The tobacco material may be provided in any suitable form, including, but not limited to, (i) cut filler tobacco, (ii) tobacco lamina, (Hi) processed tobacco materials, such as volume expanded or puffed tobacco, (iv) processed tobacco stems, such as cut-rolled or cut-puffed stems, (v) reconstituted tobacco materials, (vi) blends thereof, and the like. Tobacco substitutes may also be used. Cut filler tobacco is preferred.

In traditional cigarette manufacture, the tobacco is normally used in the form of cut filler, i.e., in the form of shreds or strands cut into widths ranging from about 2.5 mm ( 1/10 inch) to about 1 mm ( 1/20 inch) or even about 0.5 mm ( 1/40 inch). The length of individual tobacco strands range from between about 6 mm (0.25 inch) to about 75 mm (3.0 inches). Tobacco materials used for cigarettes may further include one or more flavorants, or other suitable additives (e.g., burn additives, combustion modifying agents, coloring agents, binders, etc.),

### Cigarette Structure

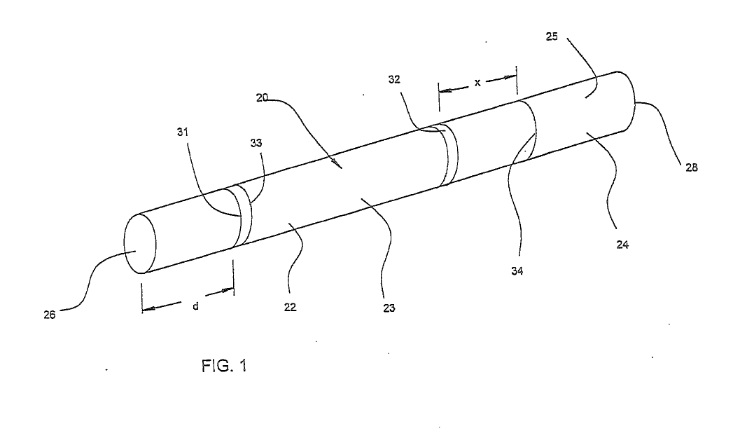

Turning to FIG. 1, a cigarette 20 in accord with this disclosure typically includes a tobacco rod 22 having a lightable end 26 and a second end 34. The second end 34 may be the mouth end, or may be provided with a filter 24 having an end 28. Conventionally, the filter 24 is attached to the tobacco rod 22 by tipping paper 25 The tobacco rod 22 includes a quantity of tobacco material as discussed above, and is surrounded by a wrapper paper 23.

Certain jurisdictions now require that cigarettes offered for sale must comply with ignition propensity requirements which statistically define the portion of cigarettes that will burn from the lit end 26 to the filter end 34 when resting on a predefined substrate under specific conditions. For example, ASTM Standard E2187-04 is a testing protocol relied upon for satisfaction of such ignition propensity requirements. One method of meeting those requirements involves providing one or more banded regions 30, 32 spaced along the tobacco rod 22. These bands 30, 32 are part of the wrapper paper 23 and may extend circumferentially around the tobacco rod 22. Typically the bands have a width, measured along the longitudinal axis of the tobacco rod, in the range of about 5 mm to about 7 mm.

In conventional cigarette manufacture, the tobacco rod is formed as the wrapper paper moves along its longitudinal axis. Tobacco material is deposited on the moving wrapper paper, which is then wrapped around the tobacco and cut to form the tobacco rod 22. Heretofore, that conventional cigarette manufacture process led to a random or quasi-random positioning of the band 30 relative to the lightable end 26 of the cigarette.

In accord with this disclosure, it is preferred that the first band 30 be located at a first predetermined distance from the lit or lightable end 26 of the cigarette. Preferably, that predetermined distance lies in the range of about 12 mm to about 18 mm. When that predetermined distance is substantially uniformly maintained during cigarette manufacture, the resulting cigarettes 20 have improved ignition propensity performance when tested.

### Banded Cigarette Paper

The presently disclosed banded cigarette paper 23 may be manufactured by a method and using an apparatus such as disclosed in commonly owned U.S. Pat. No. 6,596,125, hereby incorporated by reference in its entirety, which relates to a method and apparatus for applying a predetermined pattern of add-on slurry material to a base web, preferably in the form of transversely extending stripes. More particularly, that patent concerns a method and apparatus for producing cigarette paper having banded regions of additional material. As disclosed therein, the banded regions may exhibit a slower burn rate than those regions of the base web located between the banded regions. Further disclosures related to banded cigarette paper include commonly owned U.S. Pat. No. 5,417,228, U.S. Pat. No. 5,474,095, and U.S. Pat. No. 5,534,114, each of which is hereby incorporated by reference in its entirety. The banded regions can also be formed by other techniques such as printing, specifically gravure printing. See commonly owned U.S. Pat. No. 5,417,228 and U.S. Pat. No. 5,144,964, each of which is hereby incorporated by reference in its entirety. The widths of the banded regions preferably lie in the range of about 5 mm to about 7 mm, and more preferably about 6 mm.

The resulting banded cigarette wrapper paper 23 typically is wrapped on a bobbin. Each bobbin may, for example, hold a strip of paper with a length on the order of 6000 meters. The width of the paper strip on a bobbin is related to the circumference of the cigarettes to be formed. Usually, the width exceeds the cigarette circumference sufficiently to include a glue strip area.

### Cigarette Production

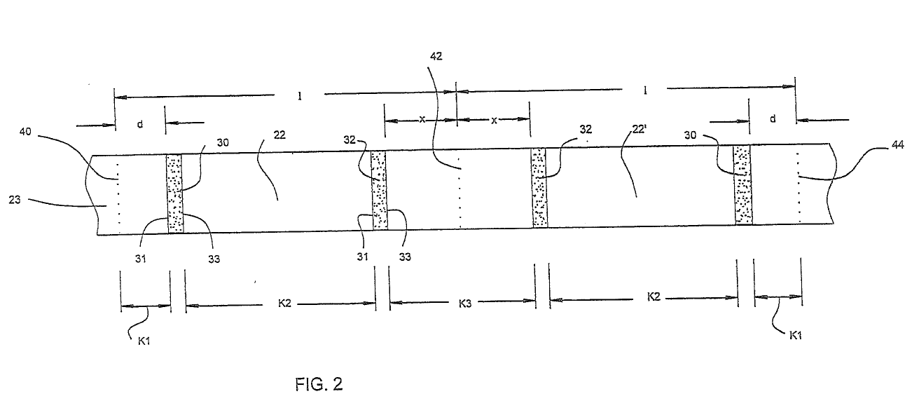

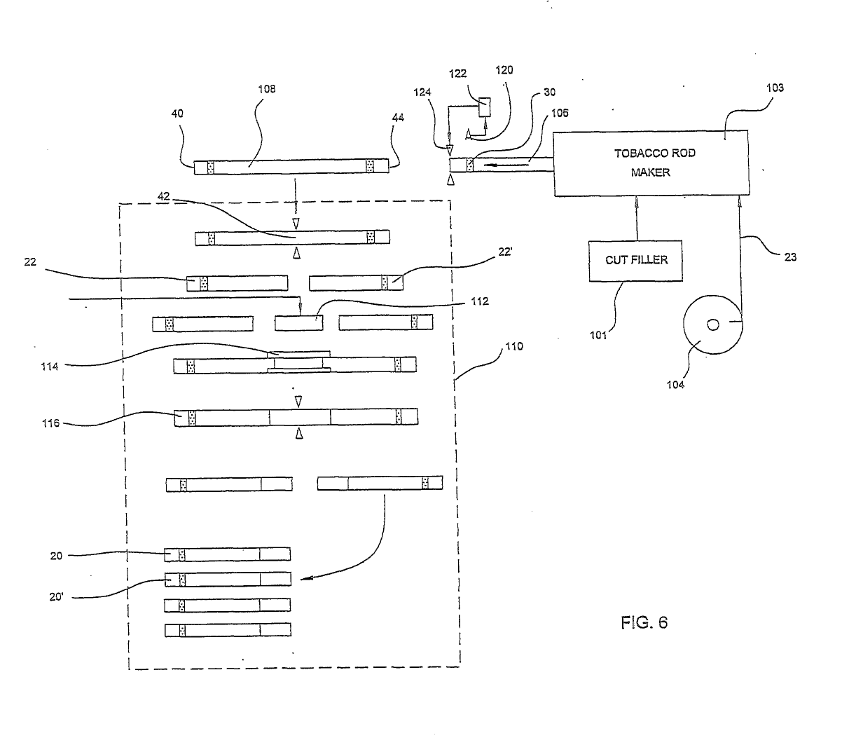

Referring to FIG. 6, in the production of cigarettes, cut filler tobacco 101 is continuously disposed along an advancing strip of cigarette wrapping paper 23, which is supplied from a bobbin 104 at a tobacco rod maker 103. The paper is wrapped around the filler tobacco, making a substantially continuous, long, column 106. That column 106 is cut into two-up rods 108 suitable for making two individual cigarettes 20, 20′. For example (see FIG. 2), the column may be transversely severed at locations 40, 44 at the rod maker 103 to produce tobacco rods 108 having a nominal length 2l. The two-up tobacco rods 108 are then fed into a tipping machine 110 such as a Hanau MAX, wherein the two-up tobacco rods 108 are cut at a location 42 into two tobacco rods 22, 22′, which are moved apart to receive a two-up filter segment 112 therebetween. The two-up filter segment 112 is attached to the longitudinally spaced pair of cigarette tobacco rods 22, 22′ using tipping paper 114. The double-length cigarette assembly 116 is then cut in half to produce two finished cigarettes 20, 21 (see FIG. 1). It is possible that the multiple tobacco rod be two-up, four-up, six-up or the like and that other tipping operations be used.

The banded regions 30 may comprise additional add-on material and/or burn rate modifiers to achieve desired reductions in ignition propensity. In addition, or in lieu of, the banded regions 30 may be used to impart subjective qualities of the cigarette. For example, banded regions may comprise flavoring. Banded regions comprising flavoring may exhibit a burn rate equal to non-banded regions of the cigarette paper or may exhibit a slower burn rate as compared to adjacent non-banded regions of the cigarette paper.

Each band 30, 32 is configured to have a leading edge 31 and a trailing edge 33, in the sense that a smoldering coal first approaches the leading edge 31.

Location, or position, of the bands in a finished cigarette depends on the nominal length l of cigarette tobacco rods sliced from a tobacco rod made using the banded cigarette paper. As noted, the bands typically have a constant width. Where all bands of the strip of cigarette wrapper paper have a uniform spacing (i.e., the distance from the end of one banded region—the trailing edge 33—to the beginning of the next banded region—the leading edge 33—is a constant value), the banded regions will be randomly or quasi-randomly arranged on the finished cigarettes.

### Registration

The presently disclosed cigarette paper 23 (see FIG. 1) is preferably designed so that banded regions of a finished cigarette are positioned, or registered, relative to a structure of the finished cigarette 20 such as the lightable end 26, or the mouth end 34, or both. The disclosed cigarette paper 23 may be designed such that each tobacco rod 22 made from the cigarette paper 23 has at least two banded regions 30, 32, one being registered relative to the lit end 26, and one being registered relative to the filter end 34 or 28. Typically, each band 30, 32 exhibits a slower burn rate in comparison to adjacent non-banded regions of the cigarette paper 23.

A first banded region 30 begins at a leading edge e31 that is a predetermined distance, d, from a first end (i.e., lit end 26) of the cigarette tobacco rod and a second banded region 32 whose trailing edge 33 is a predetermined distance, x, from a second end (i.e., mouth end or filter end) of the cigarette tobacco rod 22. As illustrated in FIG. 2, which shows a portion of a continuous strip of cigarette paper with four banded regions for forming two cigarettes, each cigarette having two banded regions. Preferably, the distance x of a second banded region from a second end (mouth end) of the cigarette tobacco rod lies in the range of about 10 mm to about 20 mm, more preferably about 10 mm for a king size 84 mm cigarette.

Thus, registered banded cigarette paper comprises band spacing, starting from a first registered location 40 on the banded cigarette paper 23 and ending at a second registered location 44 on the registered banded cigarette paper 23. The registered locations 40, 44 are where the cutter of the tobacco rod maker repetitively cuts to form a two-up tobacco rod 22, 22′, registered location 42 is where the cutter on the tipping machine cuts the two-up tobacco rod 22, 22′ to form two cigarettes 20. The paper (wrapper) 23 is provided with a pattern that repeats every length 2l:

K₁,K₂,K₃,K₂,K₁;

wherein l is the nominal tobacco rod length, K, corresponds to spacing between the first registered location 40 on the registered banded cigarette paper 23 and the leading edge 31 of the first band 30 (or the first predetermined distance d); K₂ corresponds to spacing between the trailing edge 31 of the first band 30 and the leading edge 31 of the last band 32 of the wrapper paper (the second band in FIGS. 1 and 2) within a length l; and K₃ corresponds to twice the spacing between the trailing edge 33 of last band 32 and a second registered location 42 on the banded cigarette paper 23. The spacing between the first registered location 40 and the second registered location 42 is preferably selected to correspond to an integral number times the length of the tobacco rod l to be used.

Preferably, the pattern repeats multiple times along the length of the wrapper paper 23. Where the preferred spacing of the bands is the same for the lit end and the mouth end of the tobacco rod. K₃ may be equal to 2K₁, such that the pattern would be equivalent to:

K₁,K₂,2K₁,K₂,K₁.

In general, a tobacco rod 22 having a predetermined length, l, formed from registered banded cigarette paper, may have n bands each having a width w, with n being greater than or equal to 2. Preferably, n is less than or equal to 10. Most preferably, n may be equal to 2 or 3. For a tobacco rod having length l and n bands of width w,

2K₁+2K₂+K₃2(l−nw).

Accordingly, with the foregoing relationship, knowing the nominal length l, the first predetermined distance d, the second predetermined distance x, the number of bands n, and the number of bands n for each cigarette, the required spacing K₂ between the end of the first band and the beginning of the last band can be determined.

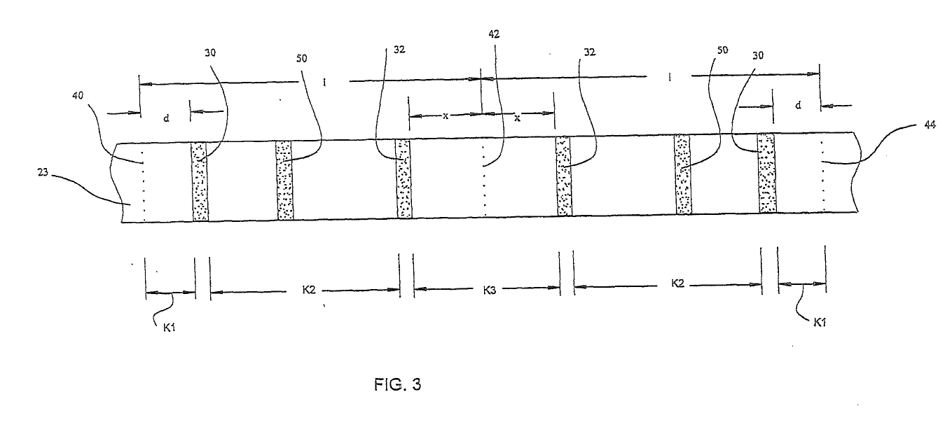

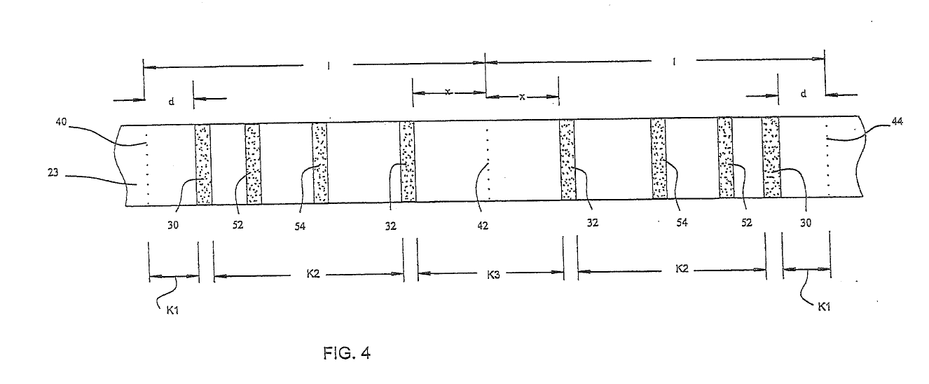

Turning to FIG. 3, a portion of a continuous strip of cigarette paper 23 shows a possible arrangement for six banded regions 30, 32, 50 for forming two cigarettes, each cigarette having three banded regions. While the interband spacing between the banded regions 30, 50, 32 is not uniform, that interband spacing may be uniform if desired. FIG. 4 shows a portion of a continuous strip of cigarette paper 23 with eight banded regions 30, 52, 54, 32 for forming two cigarettes, each cigarette having four banded regions. Here again, while the spacing between the banded regions 30, 52, 54, 34 is not uniform in FIG. 4, that interband spacing may be uniform if desired.

Spacing between adjacent bands on a tobacco rod 22 formed from the banded cigarette paper 23 of this disclosure may be represented as follows:

s₁ is the distance between the trailing edge 33 of the first band 30 and the leading edge 31 of the second band,

s₂ is the distance between the trailing edge 33 of the second band and the leading edge 31 of a third band,

sₙ₋₁ is the distance between an (n−1)th band and a last band 32.

Thus, a cigarette tobacco rod having two bands will only have a corresponding distance s₁, as the second band is the last band; a cigarette tobacco rod having three bands will have corresponding distances s₁ and s₂, as the third band is the last band; and a cigarette tobacco rod having n bands will have corresponding distances s₁, s₂, . . . , sₙ₋₁, as the (n−1)th band is the last band. Further, K₂, which corresponds to spacing between a first band and a last band, is equal to w(n−2)+s₁+s₂+ . . . +sₙ₋₁. When n is greater than or equal to 3, distances between adjacent bands (i.e., s₁, s₂, . . . , sₙ) may be equal, in which case s₁=s₂= . . . =(l−nw−K₁−K₃)/n.

To avoid randomly or quasi-randomly arranged banded regions on cigarettes, the width of the bands (i.e., for two cigarette tobacco rods) plus the pattern of band spacing (i.e., K₁, K₂, K₃, K₂, K₁) is made to correspond with the length 2l of two cigarette tobacco rods formed from the registered banded cigarette paper.

From the foregoing description and FIGS. 2 to 4, it will be seen that the wrapper paper 23 exhibits a repeating pattern along its longitudinal length. That pattern has a predetermined length, preferably corresponding to twice the nominal length l of a tobacco rod for a cigarette. That predetermined length is measured from the first registered location 40 to the second registered location 44. Furthermore, within the predetermined length, the pattern is symmetrical about a transverse axis corresponding to the registered location 42. During manufacture of a smoking article, the tobacco rod maker 103 (see FIG. 6) cuts or otherwise severs the continuous tobacco rod 106 at the first and second registered locations 40, 44 so as to form, for example, a two-up tobacco rod having the predetermined length. The tipping machine 110 cuts or otherwise severs the two-up tobacco rod at the axis of symmetry for the pattern, so that the resulting smoking articles have substantially uniform spatial positioning of the banded regions relative to the lightable or lit end of the smoking article.

### EXAMPLES

A series of prototype cigarettes has been prepared using various levels of chalk loading, all less than 12%. The prototype series are identified in the following table as A, B, C, and D. The table below summarizes testing of those prototype cigarettes which was conducted according to ASTM Standard E2187-04.

Results of the testing are tabulated in the following table according to the prototype, and according to the distance from the lit end to the first banded region. The first data column summarizes the results for cigarettes where the first banded region 30 begins 12 mm to 18 mm from the lit end of the cigarette (d or K₁). The second data column summarizes the results for cigarettes where the first banded region begins outside the region of 12 mm to 18 mm from the lit end of the cigarette. For each prototype, the number of Full-Length Burns (FLB), and Extinguishments (EXT) when tested is recorded, along with the total number of cigarettes of that prototype tested that also fell within the distance range from the lit end of the cigarette. As used herein, extinguishment refers to a non-full-length burn. In short, the data indicate that the cigarettes having the first banded region in the range of 12 mm to 18 mm from the lit or lightable end exhibit a substantially reduced percentage of cigarettes that yield a free-length burn when contrasted to cigarettes where the first banded region is outside that range.

TABLE

Beginning of Banded Region
from Lit End of Cigarette

| Test | | 12 mm to | <12 mm or | |
|---|---|---|---|---|
| sample | | 18 mm | >18 mm | |
| A | FLB | 3 | 35 | |
| | EXT | 41 | 80 | |
| | Total | 44 | 115 | |
| B | FLB | 2 | 26 | |
| | EXT | 32 | 97 | |
| | Total | 34 | 123 | |
| C | FLB | 7 | 46 | |
| | EXT | 32 | 74 | |
| | Total | 39 | 120 | |
| D | FLB | 17 | 91 | |
| | EXT | 19 | 33 | |
| | Total | 36 | 124 | |
| Total | FLB | 29 | 198 | 227 |
| | EXT | 124 | 284 | 408 |
| | Total | 153 | 482 | 635 |

At the bottom, the table summarizes the results achieved with all the prototypes. For cigarettes with the first band in the preferred range, free-length burn occurred in only about 4.6% of the cigarettes tested. In contrast, for cigarettes in which the first band is outside the preferred range, free-length burn occurred in about 31.2% of the cigarettes tested. Since the percentage of free-length burn is related to ignition propensity, these tests show that ignition propensity of cigarettes outside the preferred range is approximately 7 times the ignition propensity of cigarettes with the first band inside the preferred range.

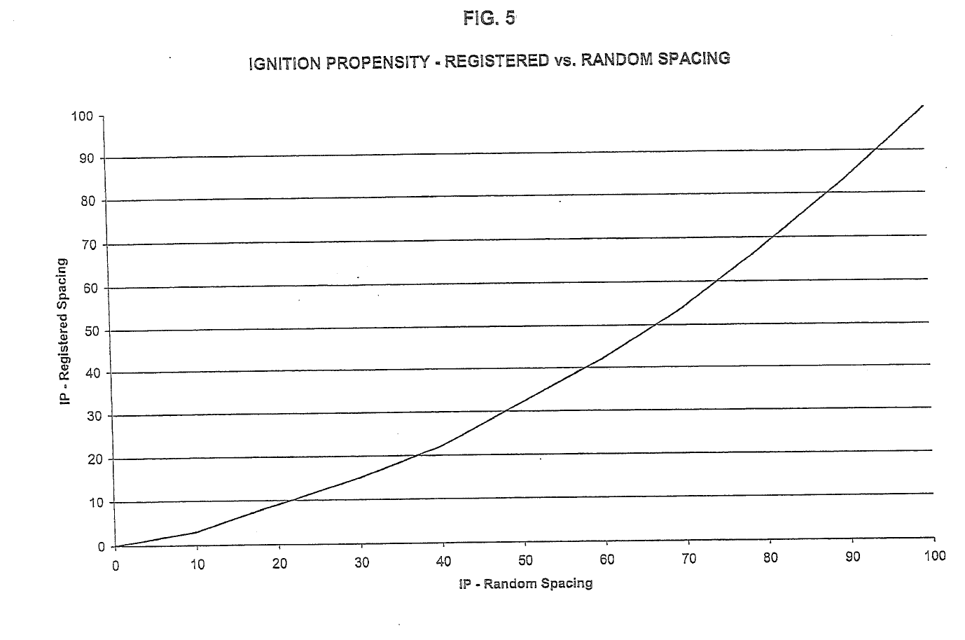

FIG. 5 compares the percent full-length burns for the four prototype cigarettes listed in the Table as well as four additional prototype cigarettes, all with banded regions beginning 12 mm to 18 mm from the lit end of the cigarette, to the percent full-length burns for the four prototype cigarettes listed in the Table as well as four additional prototype cigarettes, all with randomly placed banded regions. The randomly placed banded regions may begin less than 12 mm from the lit end of the cigarette, 12 mm to 18 mm from the lit end of the cigarette, or greater than 18 mm from the lit end of the cigarette. The dashed line is the best fit to the data points. FIG. 5 illustrates that cigarettes having a banded region beginning 12 mm to 18 mm from the lit end of the cigarette are less likely, specifically up to approximately three times less likely, to exhibit full-length burns when compared to cigarettes having a randomly placed banded region.

To make effective use of this data in manufacturing cigarettes, the wrapper paper is prepared with banded regions which repeat along the longitudinal length thereof according to the K1, K2, K3, K2, K1 pattern discussed above. The wrapper paper having the predetermined banding pattern is fed into the garniture machine during cigarette making and a first cut of the tobacco column is made at a location spaced from the first banded region 30 (see FIG. 2) by a predetermined distance lying in the range of about 12 to about 18 mm. Accordingly, each successive cut of the tobacco column prepares a double length tobacco rod, which is then severed to make two cigarettes. A filter may be applied as discussed above. Referring now to FIG. 6, the desired cutting operations are achieved at the rod maker 103 with a sensor 120 adapted to generate a signal upon detection of a banded region 30 and/or 32 and a processor 122 adapted to cause operation of the cutter 124 responsively to the signal generated by the sensor 120.

With this process, each cigarette 20 (see FIG. 1) will have the first banded region positioned at the predetermined distance from the lit or lightable end of the cigarette. Moreover, a each cigarette in a pack of 20 such cigarettes will also have the first banded region positioned at the predetermined distance from the cigarette end. Using this registration method, and wrapper construction process, it is also possible to treat selected bands differently than other bands, depending on desired characteristics. For example, it would be possible to add a flavorant to the first banded region to enhance smoking enjoyment. It would also be possible to modify the last banded region of the cigarette in a way that may statistically more often cause a cigarette to extinguish when left unattended upon a substrate. For example, the last banded region might comprise additional add-on material or a greater width.

While various embodiments have been described, it is to be understood that variations and modifications may be resorted to as will be apparent to those skilled in the art. Such variations and modifications are to be considered within the purview and scope of the claims appended hereto.

1. A registered banded wrapper of a smoking article, wherein band spacing starting from a first location on the registered banded wrapper and ending at a second location on the registered banded wrapper has a pattern:
K₁,K₂,K₃,K₂,K₁
wherein:
K₁ corresponds to spacing between the first location on the registered banded wrapper and a first band;
K₂ corresponds to spacing between a first band and a last band; and
K₃ corresponds to twice the spacing between the last band and a second location on the registered banded wrapper.

2. A registered banded wrapper according to claim 1 wherein the pattern repeats.

3. A registered banded wrapper according to claim 1 wherein K₃=2K₁.

4. A registered banded wrapper according to claim 1 wherein K₁ is in the range of about 12 mm to 18 mm.

5. A registered banded wrapper according to claim 1 wherein K₁ is about 15 mm.

6. A registered banded wrapper according to claim 1 wherein K₃ in the range of about 20 mm to 40 mm.

7. A registered banded wrapper according to claim 1 wherein K₃ is about 20 mm.

8. The registered banded wrapper of claim 1, wherein a tobacco rod having a length, l, formed from the registered banded wrapper comprises n bands of width w, wherein n is greater than or equal to 2 and less than or equal to 10.

9. A registered banded wrapper according to claim 8 wherein w is in the range of about 5 mm to 7 mm.

10. A registered banded wrapper according to claim 8 wherein l is in the range of about 50 mm to 100 mm.

11. A method of making a registered banded wrapper according to claim 1 comprising applying bands to a base web, wherein band spacing starting from a first location on the base web and ending at a second location on the base web has a pattern:
K₁,K₂,K₃,K₂,K₁
wherein:
K₁ corresponds to spacing between the first location on the base web and a first band;
K₂ corresponds to spacing between a first band and a last band; and
K₃ corresponds to twice the spacing between the last band and a second location on the base web.

12. A method of making a cigarette tobacco rod comprising:
wrapping a registered banded wrapper according to claim 1 around cut filler tobacco to make a tobacco rod; and
slicing the tobacco rod to a cigarette tobacco rod length.

13. A cigarette comprising a tobacco rod of predetermined length having a lightable end and wrapping paper surrounding the tobacco rod, the wrapping paper including at least one generally circumferential band spaced by a substantially uniform, predetermined offset from the lightable end of the tobacco rod.
